(19) United States
(12) Patent Application Publication
(10) Pub. No.: US 2017/0166095 A1
(43) Pub. Date: Jun. 15, 2017

(54) MOTOR VEHICLE WITH HEIGHT-ADJUSTABLE SEAT

(71) Applicant: GM GLOBAL TECHNOLOGY OPERATIONS LLC, Detroit, MI (US)

(72) Inventor: Andrzej PLESKOT, Ruesselsheim (DE)

(73) Assignee: GM GLOBAL TECHNOLOGY OPERATIONS LLC, Detroit, MI (US)

(21) Appl. No.: 15/374,246

(22) Filed: Dec. 9, 2016

(30) Foreign Application Priority Data
Dec. 9, 2015 (DE) 102015015878.3

(51) Int. Cl. B60N 2/16; B62D 31/00; B60R 22/00; B60N 2/02; B60N 2/06

(52) U.S. Cl. CPC B60N 2/165; B60N 2/0232; B60N 2/06; B60R 22/00; B60N 2/1615; B62D 31/00

(57) ABSTRACT

A motor vehicle includes a vehicle body, a drive motor, particularly an electric motor and/or a combustion engine, a seat with a frame, and a mechanism for adjusting the height of the seat. The mechanism includes a front lever and a rear lever, each fixed in articulated manner to the frame via an upper articulated joint and to a retaining structure via a lower articulated joint so that swiveling of the front and rear levers causes a height adjustment of the seat. An actuator affects motorized adjustment of the seat height. An auxiliary mechanism supplements the front and rear levers such that a force, particularly a turning moment, applied to the auxiliary mechanism by the actuator adjust the height of the seat.

### CROSS-REFERENCE TO RELATED APPLICATION

This application claims priority to German Patent Application No. 102015015878.3, filed Dec. 9, 2015, which is incorporated herein by reference in its entirety.

### TECHNICAL FIELD

The present disclosure pertains to a seat for a motor vehicle, and more particularly to a seat having a height adjustment feature.

### BACKGROUND

Motor vehicles have an interior space, and seats are arranged in the interior space. In this context, front seats have a seat part and a back part. The back part is mounted so as to be pivotable about a swivel axis. Rear seats are arranged behind the front seats in the interior space of the motor vehicle. The rear seats are generally combined so that a rear bench seat is created from multiple seats. The front seats include a frame, and an upholstery element having a seat cover fastened to the frame.

The front seat may be moved vertically by an electric motor and a mechanism in such manner that the front seat is height-adjustable. Two front and two rear levers are each connected to the frame in articulated manner via an upper articulated joint and to a retaining structure via a lower articulated joint. The electric motor and a gearbox are fixed on the frame, and a curved toothed rack is fixed to one of the two rear levers. The teeth of the toothed rack mesh with a gearwheel on the gearbox. In this way, a turning moment or force may be applied to the rear lever in order to turn the rear lever, so that the front seat may be moved vertically due to the kinematics of the levers.

In this context, the electric motor and the gearbox are fixed to an outer side of a side member of the frame, between the side member and side of the vehicle body. This may cause operating noises produced by the electric motor and the gearbox to reach the interior space substantially unimpeded. A belt buckle is fastened to the retaining structure, with the unfavorable result that the belt buckle does not move vertically with the front seat.

Accordingly, there is a need to provide a motor vehicle in which the height adjustment mechanism and the actuator emit only a small amount of noise into the interior space, and the belt buckle for the seat may be fixed on the vertically movable frame.

### SUMMARY

The present disclosure provides a motor vehicle having a vehicle body having a seat assembly and a drive motor, particularly an electric motor and/or a combustion engine. The seat assembly includes a seat with a frame, a mechanism for adjusting the height of the seat with a front lever and a rear lever. The front and rear levers are each fixed in articulated manner to the frame by an upper articulated joint and to a retaining structure by a lower articulated joint, in such manner that pivoting movement of the front and rear levers causes an adjustment of the height of the seat. An actuator provide for motorized height adjustment of the seat. The motor vehicle includes an auxiliary mechanism to supplement the front and rear levers, and a force, particularly a turning moment may be exerted on the auxiliary mechanism by the actuator to adjust the height of the seat. The turning moment or force for adjusting the height of the seat, that is to say for moving the seat in a vertical direction, may thus be transmitted from the actuator to the seat via an auxiliary mechanism.

This advantageously enables the actuator to be fixed to the frame in the region of an inner side of the frame as well, with the result that only small fraction of the noises from the actuator or a gearbox is emitted into the interior space of the motor vehicle. The seat thus functions advantageously as sound insulation or sound isolation for the noises generated by the actuator and preferably by a gearbox. The frame is fastened to the retaining structure additionally by the auxiliary mechanism, thus enabling a belt buckle to be fastened to the frame as well. The strong forces that are transferred from the belt buckle to the frame in the event of an accident may thus be transferred to the retaining structure both by the mechanism and by the auxiliary mechanism, so that the powerful forces generated in the accident can be transferred safely from the frame to the retaining structure by the mechanism and the auxiliary mechanism. This further enables the belt buckle to be fastened to the seat in such manner that the belt buckle also follows the seat when the seat undergoes a vertical movement.

In a further variation, the force, particularly the turning moment for adjusting the height of the seat may be applied to the auxiliary mechanism exclusively by the actuator. As a result the actuator does not exert any forces on the mechanism, with the result that the mechanism only serves for the kinematic height adjustment of the seat.

In a further variation, the auxiliary mechanism includes a first auxiliary lever fixed to the frame via an upper auxiliary articulated joint and a second auxiliary lever fixed to the retaining structure via a lower auxiliary articulated joint. The first and second auxiliary levers are connected to each other in articulated manner via a connecting articulated joint. The actuator is expediently connected mechanically to a gearbox, and the force, particularly the turning moment, can be transmitted from the actuator to the auxiliary mechanism of the gearbox by the actuator.

In a further variation, the actuator and preferably the gearbox as well is fixed to the auxiliary mechanism. In an additional variation, the actuator and preferably the gearbox as well is fixed to the first or second auxiliary lever. The actuator and preferably the gearbox may thus be entrained in a movement of the auxiliary mechanism.

In a further variation, the actuator and the gearbox are fixed to one auxiliary lever a toothed rack is fixed to another auxiliary lever, and a gearwheel on the gearbox meshes with the teeth of the toothed rack to transmit the turning moment. Due to the connecting articulated joint, the first and second auxiliary levers form a shearing structure. The angle between the first and the second auxiliary levers may be changed by the application of a turning moment by the gearwheel, and the vertical position of the seat altered due to the kinematics of the front and rear levers. The gearbox has a large reduction ratio, such that when the actuator is switched off the angle between the first and the second levers is fixed and in turn a vertical movement of the seat is blocked due to the kinematics of the mechanism and of the auxiliary mechanism. The auxiliary mechanism together with the actuator and the gearbox thus also functions as a locking device for locking the seat in a given vertical position.

In a further variation, the toothed rack has a curved shape, in particular the toothed rack is designed coaxially with a swivel axis of the connecting articulated joint. The coaxial design of the toothed rack with the swivel axis of the connecting articulated joint is necessary to ensure that the teeth of the gearwheel always mesh with the teeth of the toothed rack when the first and second auxiliary levers are swiveled towards each other, that is to say the angle between the first and second auxiliary levers is changed.

In a further variation, the kinematics of the auxiliary mechanism is designed such that the distance, particularly the vertical distance, between the actuator and an upholstery element and/or a seat cover of a seat part of the seat is substantially constant. A substantially constant vertical distance means that the vertical distance between the actuator and the upholstery element and/or the seat cover varies by less than 40%, 30%, 20%, 10% or 5% in all vertical positions of the seat. Since the vertical distance is permanently constant and sufficiently large, the noise burden in the interior space of the vehicle is low.

In a further variant, the actuator is arranged in the area of an interior of the frame. Due to the arrangement of the actuator and preferably of the gearbox in the interior area of the frame, the seat, and particularly the upholstery element of the seat, functions as sound insulation for the noises generated by the actuator and the gearbox. In this way, very little noise penetrates the interior space of the motor vehicle when the actuator is activated.

In an additional embodiment, the actuator is arranged between two side members of the frame. The actuator is advantageously an electric motor. In a further variant, the actuator is a pneumatic or hydraulic actuator.

In a further variant, the seat includes two rails, and the retaining structure is supported as a carriage that is mounted so as to be movable in the lengthwise direction on the rails. Thus, the retaining structure is preferably formed by the at least one movable carriage. In this way, the entire seat may be moved in a lengthwise direction of the motor vehicle. If the seat is not displaceable in the lengthwise direction, the retaining structure may also consist of feet, for example, which are fastened to the body of the motor vehicle. The retaining structure may also consist of at least one intermediate member and preferably the carriage.

In a further variant, the motor vehicle includes a seatbelt for the seat, and a belt buckle for securing the seatbelt to the frame, particularly to a rear area of the frame. When the seat undergoes a vertical movement, the belt buckle also undergoes the same vertical movement together with the seat. Consequently, the position of the belt buckle relative to the seat does not change when the seat moves vertically, which means that the belt buckle is always arranged in the same position on the seat part. This serves to improve the convenience of the seat. The belt buckle is preferably fixed to a rear end area of the frame, particularly a rear end area of a side member of the frame. Both the rear lever of the mechanism and the auxiliary mechanism are connected to both the frame and the retaining structure via the first and second auxiliary levers at this rear end area of the frames. The powerful forces that are generated in the event of an accident, and which are transferred from the belt buckle to the frame, may thus be reliably transmitted to the retaining structure both by the rear lever and by the auxiliary mechanism via the two auxiliary levers.

In a further variant, the mechanism for adjusting the height of the seat includes two front levers and two rear levers, and the front and rear levers are each fastened to the frame by an upper articulated joint and to the retaining structure by a lower articulated joint.

### BRIEF DESCRIPTION OF THE DRAWINGS

The present disclosure will hereinafter be described in conjunction with the following drawing figures, wherein like numerals denote like elements.

FIG. 1 is a side view of a motor vehicle;

FIG. 2 is a lengthwise cross section through a front seat of the motor vehicle;

FIG. 3 is a perspective view of an auxiliary height adjustment mechanism of the seat and the fixing of the auxiliary mechanism to a frame;

FIG. 4 is a perspective view of an auxiliary height adjustment mechanism of the seat without the fixing of the auxiliary mechanism to the frame;

FIG. 5 is an exploded illustration of the auxiliary height adjustment mechanism of the seat; and

FIG. 6 is a perspective view of a part of the frame of the seat and a belt buckle.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

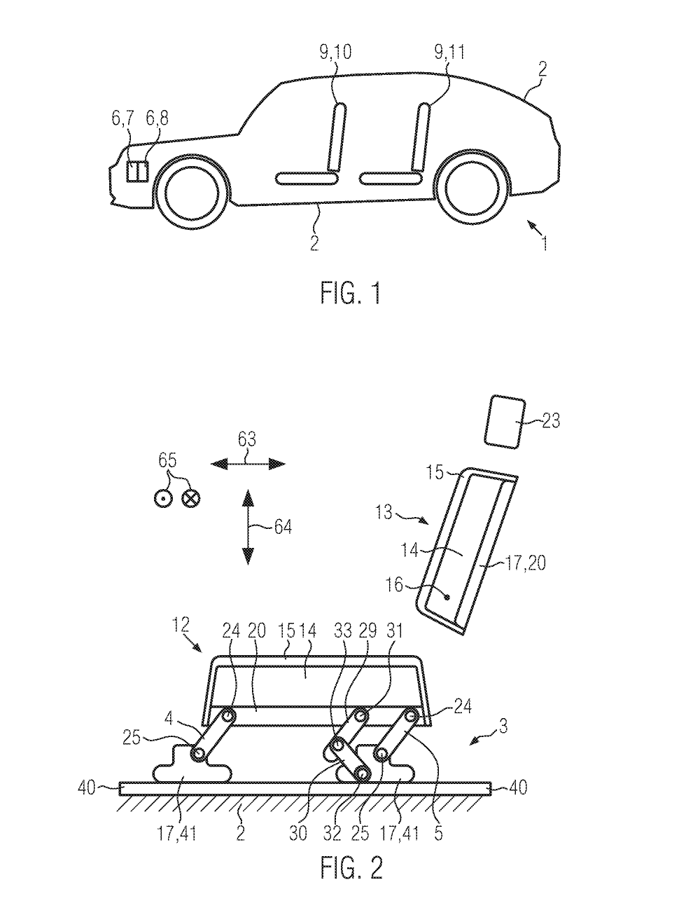

A motor vehicle represented in FIG. 1 as a hybrid or electric motor vehicle 1 has a vehicle body 2 made of metal, particularly steel. Motor vehicle 1 is propelled by a drive motor 6, for example an electric motor 7 and/or a combustion engine 8. An electric motor vehicle 1 is only equipped with electric motor 7 and a hybrid motor vehicle 1 is equipped with both electric motor 7 and combustion engine 8 as the drive motor 3. A steel vehicle body 2 delimits an interior space, and two front seats 10 are arranged as seats 9 and three rear seats 11 as seats 9 in the interior space. The three rear seats 11 are also combined to form a bench seat.

FIG. 2 represents a lengthwise cross section through front seat 10. Front seat 10 includes a seat part 12 and a back part 13. Seat part 12 and back part 13 each have a frame 20 to which an upholstery element 14 and a seat cover 15 are fastened. In addition, a headrest 23 is mounted on back part 13, and back part 13 is pivotable about a swivel axis 16. Frame 20 of back part 10 is connected to frame 20 of seat part 9 via connecting elements, so that when front seat 10 undergoes a horizontal and/or vertical movement this also causes both seat part 9 and back part 10 to undergo the same horizontal and/or vertical movement together. Front seat 10 is fixed on vehicle body 2 via two rails 40.

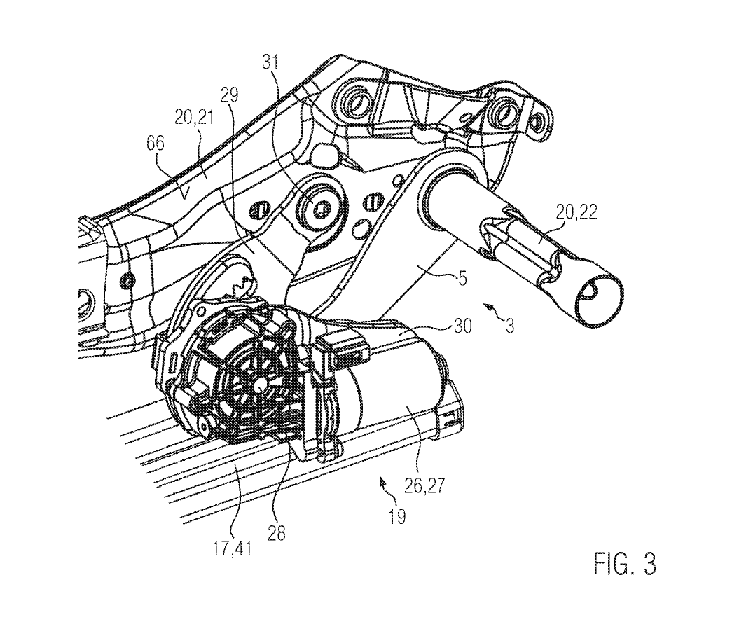

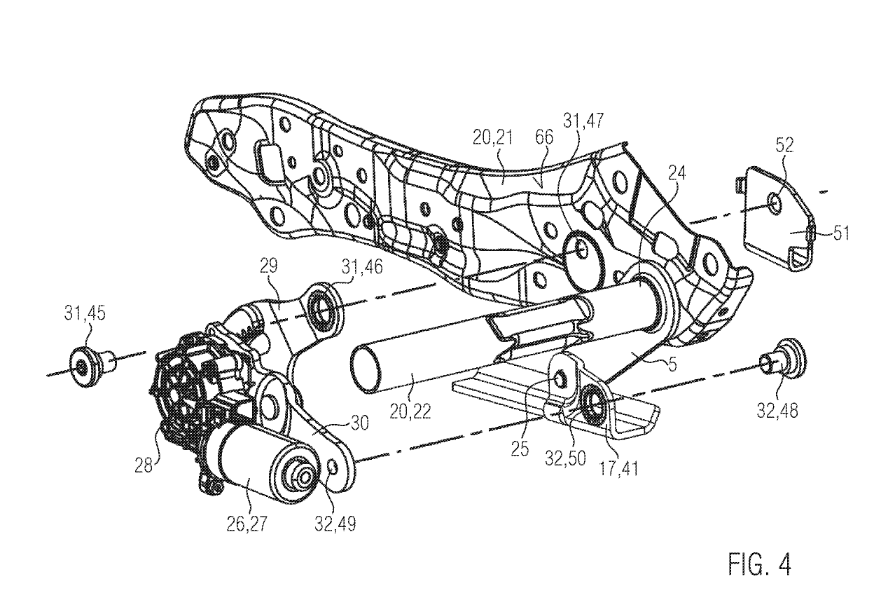

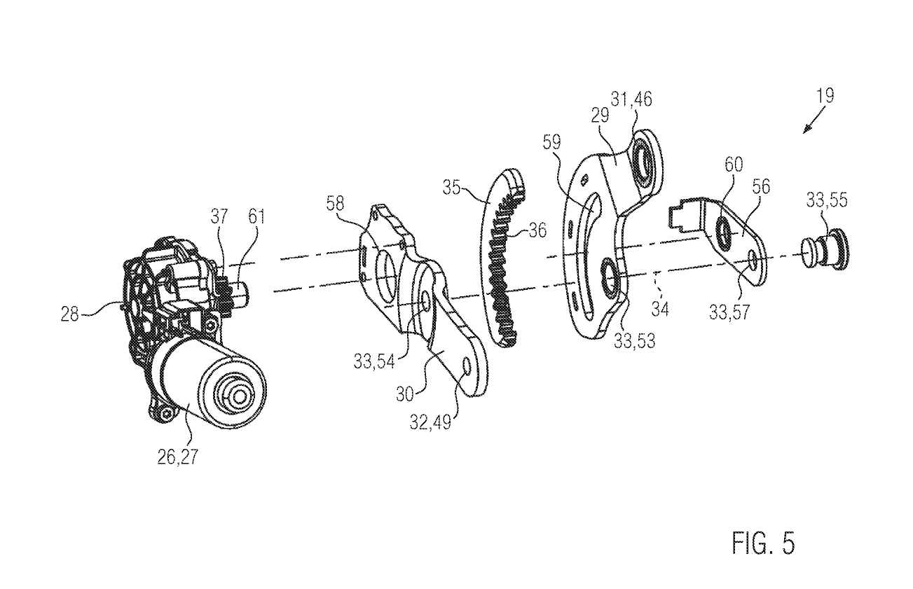

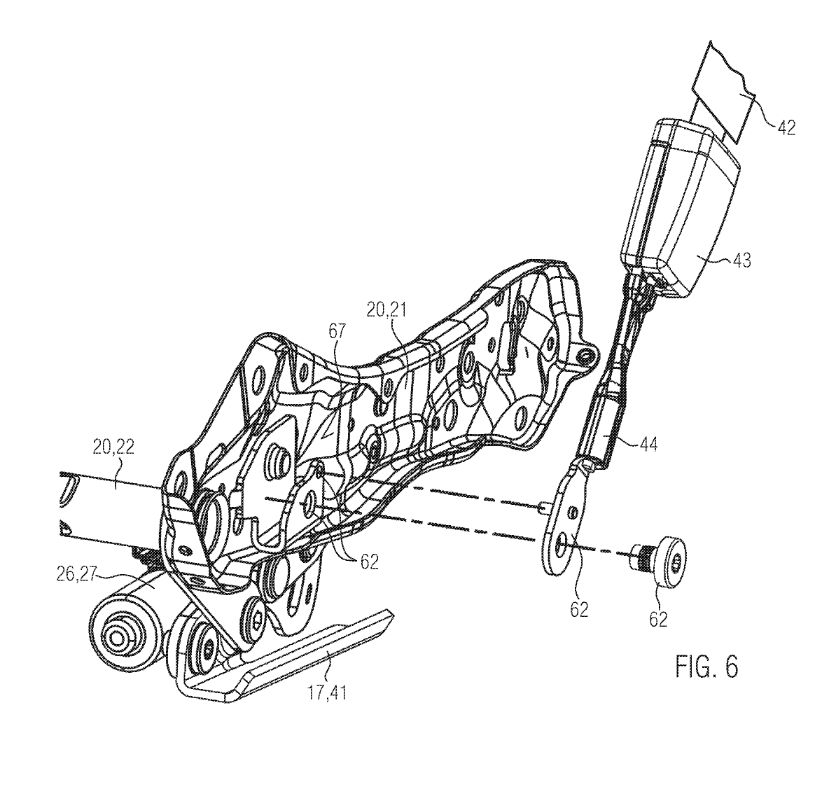

Seat 9 includes a mechanism 3 for adjusting the height of seat 9. Mechanism 3 includes two front levers 4 and two rear levers 5. The two front levers 4 are each fixed to the frame 20, that is to say a side member 21 of frame 20, by an upper articulated joint 24. The two front levers 4 are fixed on a carriage 41 via a lower articulated joint 25 by a lower end area of front levers 4, and carriage 41 forms a retaining structure 17. The two side members 21 of frame 20 are each connected to each other in the rear and front areas via a cross member 22 in each case. FIGS. 3 and 4 only show the rear cross member 22, front cross member 22 is not represented. Each rear lever 8 is connected in articulated manner to side member 21 in a rear and area of both side members 21 via an upper articulated joint 24 and in articulated manner to carriage 41 via a lower articulated joint 25. In this context, front and rear levers 4, 5 are aligned at an acute angle in the range from about 20° to 70° relative to a notional horizontal plane. Accordingly, swiveling front and levers 4, 5 thus causes seat 9 to move in a vertical direction 64 and also brings about a movement of seat 9 in a lengthwise direction 63 and a horizontal direction. In a transverse direction 65 of motor vehicle 1, movement or swiveling of the two front levers 4 and the two rear levers 5 does not cause any movement of the seat 9 in transverse direction 65. Only one of the two front levers 4 and only one of the two rear levers 5 is shown in FIG. 2. Levers 4, 5 are thus connected in jointed manner to frame 20 via upper articulated joint 24 for swiveling about a swivel axis and are connected to in jointed manner to carriage 41 via lower articulated joint 25 for swiveling about a swivel axis. Frame 20 is constructed from metal, particularly steel and/or aluminum.

Mechanism 3 functions solely as the kinematics for the vertical movement of seat 9. A force may be applied to move seat 9 in vertical direction 64 by an auxiliary mechanism 19 and an electric motor 27 as an actuator 26 and a gearbox 28. Auxiliary mechanism 19 includes a first auxiliary lever 29 and a second auxiliary lever 30. First auxiliary lever 29 is connected in articulated manner to side member 21 via an upper auxiliary articulated joint 31, and second auxiliary lever 30 is connected in articulated manner to carriage 41 via a lower auxiliary articulated joint 32. First and second auxiliary levers 29, 30 are also connected to each other in articulated manner via a connecting articulated joint 33. First and second auxiliary levers 29, 30 are thus configured in the manner of a shearing structure, and the angle between the first and the second auxiliary levers 29, 30 may be changed by swiveling first and second auxiliary levers 29, 30 relative to each other about a swivel axis 34 at connecting articulated joint 33. For this purpose, a toothed rack 35 with teeth 36 is fixed on first auxiliary lever 29. Toothed rack 35 is curved in shape, and is also arranged coaxially with swivel axis 34, so that when first and second auxiliary levers 29, 30 are swiveled towards each other the radial distance between teeth 36 and swivel axis 34 remains constant. Electric motor 27 and gearbox 28 are fixed on second auxiliary lever 30.

Upper auxiliary articulated joint 31 is created by a screw 45, a through hole 46 in first auxiliary lever 29 and a through hole 47 in frame 20 as side member 21. Lower auxiliary articulated joint 32 is created by a screw 48, a through hole 49 in second auxiliary lever 30 and a through hole 50 in retaining structure 17. Upper auxiliary articulated joint 31 is also formed by a plate 51 and a through hole 52 in plate 51. Connecting articulated joint 33 is created by a through hole 53 in first auxiliary lever 29, a through hole 54 in second auxiliary lever 30 and a rivet 55. A connecting rod 56 also has a through hole 57 for connecting articulated joint 57 and a through hole 60 for an axle 61 on a gearwheel 37 of gearbox 28. Gearwheel 37 has teeth. A kidney-shaped slot 59 is formed in first auxiliary lever 29, and kidney-shaped slot 59 is aligned coaxially with swivel axis 34. A through hole 58 is created on second auxiliary lever 30, and gearwheel 37 is mounted on gearbox 28 through through hole 58 during assembly.

In order to adjust the height of seat 9, electric motor 27 is switched on by a control unit (not shown). A drive shaft (not shown) from electric motor 27 applies a turning moment to gearbox 28. Gearbox 28 has a very large reduction ratio, so a fast rotation by the drive shaft from electric motor 27 with very low turning moment is converted into a very slow rotating movement of gearwheel 37 with a very high turning moment. As toothed rack 35 is fixed on first auxiliary lever 29 and gearbox 28 with electric motor 27 is fixed on second auxiliary lever 30 and because the teeth of gearwheel 37 mesh with the teeth 36 of toothed rack 35, the rotating movement of gearwheel 37 has the effect of changing the angle between first and second auxiliary levers 29, 30. During this swiveling, axle 61 of gearwheel 37 also performs a rotating movement in kidney-shaped slot 59 with an axis of rotation that corresponds to swivel axis 34. This change in angle between first and second auxiliary levers 29, 30 and the corresponding kinematic synchronization of first and second auxiliary levers 29, 30 as auxiliary mechanism 19 for mechanism 3 with both front levers 4 and both rear levers 5 causes a change in the vertical positions of seat 9, that is to say a movement of seat 9 in vertical direction 64. Because of the aligning of levers 4, 5 and auxiliary lever 29, 30, this movement of seat 9 in vertical direction 64 also causes a slight movement of seat 9 in lengthwise direction 63.

Each of the two side members 21 has an inner side 66 and an outer side 67. Auxiliary mechanism 19 with electric motor 27 and gearbox 28 are arranged in the area of the inner side 66 of side member 21. In this context, this is the side member 21 close to the center console. A belt buckle 43 is also fixed on this side member 21 close to the center console of motor vehicle 1 via a rod 44 with a fixing device 62. Belt buckle 43 serves to fasten a seatbelt 42 to motor vehicle 1. Rod 44 is thus fastened via a rear lever 5 and auxiliary mechanism 19 to the outer side 67 of side member 21 approximately opposite inner side 66. If the motor vehicle is involved in an accident, powerful forces are transferred from belt buckle 43 to side member 21 via rod 44. Rear lever 5 and auxiliary mechanism 19 are fastened to the inner side 66 in the rear end area of side member 21, and fixing device 62 is fastened to the outer side 67 in the area of the rear end area of side member 21. These strong forces which are transmitted from belt buckle 43 to side member 21 may thus be reliably directed to retaining structure 17 by rear lever 5 and auxiliary mechanism 19.

Retaining structure 17 is constructed in the form of a carriage 41, and seat 9 is movable in lengthwise direction 63 within a rail 40 by four carriages 41, one of which is located at each of the corners of seat 9. Seat 9 is thus displaced lengthwise by mans of a movement of carriages 41 in two rails 40. Two carriages 41 are supported movably in each rail 40, and the two rails 40 are fixed to vehicle body 2. Carriages 41 and therewith also seat 9 can be fixed in the lengthwise direction 63 by a fixing device.

Taken altogether, substantial advantages are associated with the motor vehicle 1 according to the present disclosure. Auxiliary mechanism 19 guarantees that seat 9 may be moved reliably in vertical direction 64 and also enables belt buckle 43 to be fixed on frame 20, so that belt buckle 43 also follows a movement of seat 9 in vertical direction 64. The assembly consisting of the electric motor 27, gearbox 28 and auxiliary mechanism 19 with first and second auxiliary levers 29, 30 is only attached to frame 20 and carriage 41 by the two screws 45, 48.

Accordingly, this assembly may easily be mounted on frame 20 and retaining structure 17 when motor vehicle 1 is being built. If this assembly is damaged while motor vehicle 1 is in operation, for example if the electric motor 7 is damaged, the assembly may easily be replaced in a workshop. In this way, damage to this assembly may easily be repaired in the course of a normal servicing operation in a workshop.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A motor vehicle comprising:
a vehicle body;
a seat with a frame supported within the vehicle body;
a first mechanism operably coupled between the seat and the vehicle body, the first mechanism including a front lever and a rear lever, each fixed in articulated manner via an upper articulated joint to the frame and via a lower articulated joint to a retaining structure,
a second mechanism operably coupled between the seat and the vehicle body;
an actuator configured to apply a turning moment to at least one of the first and second mechanisms for adjusting a height of the seat relative to the vehicle body.

17. The motor vehicle according to claim 16, wherein the actuator is configured to apply the turning moment for adjusting the height of the seat exclusively to the second mechanism.

18. The motor vehicle according to claim 16, further comprising a gearbox mechanically connected to the actuator, wherein the turning moment is transmitted from the actuator to the second mechanism via the gearbox.

19. The motor vehicle according to claim 18, wherein the actuator and the gearbox are fixed on the second mechanism.

20. The motor vehicle according to claim 16, wherein the second mechanism comprises a first lever fixed to the frame via a second upper articulated joint, and a second lever is fixed to the retaining structure via a second lower articulated joint, wherein the first and second levers are connected in articulated manner to each other via a connecting articulated joint.

21. The motor vehicle according to claim 20, further comprising a gearbox mechanically connected to the actuator, wherein the turning moment is transmitted from the actuator to the second mechanism via the gearbox.

22. The motor vehicle according to claim 21, wherein the actuator and the gearbox are fixed on at least one of the first or second levers.

23. The motor vehicle according to claims 21, wherein the actuator and the gearbox are fixed on the first lever, and a toothed rack is fixed on the second lever, and a gearwheel on the gearbox meshes with the toothed rack to transmit the turning moment.

24. The motor vehicle according to claim 23, wherein the toothed rack comprises a curved toothed rack having a center point that is coaxial with a swivel axis of the connecting articulated joint.

25. The motor vehicle according to claim 16, wherein the seat further comprises an upholstery element and the kinematics of the second mechanism is configured such that a distance between the actuators and the upholstery element is substantially constant.

26. The motor vehicle according to claim 16, wherein the actuator is arranged in the area of an inner side of the frame.

27. The motor vehicle according to claim 26, wherein the frame comprises two side members and the actuator is arranged therebetween.

28. The motor vehicle according to claim 16, wherein the actuator comprises an electric motor.

29. The motor vehicle according to claim 16, wherein the seat further comprises two rails and the retaining structure is supported on a carriage to be movable in a longitudinal direction in the rails.

30. The motor vehicle according to claim 16, further comprising a seatbelt for the seat and a belt buckle for the seatbelt releasably secured to the frame.

31. The motor vehicle according to claim 16, wherein the first mechanism comprises two front levers and two rear levers.
